(19) United States
(12) Patent Application Publication
(10) Pub. No.: US 2026/0162257 A1
(43) Pub. Date: Jun. 11, 2026

(54) COMPUTER-IMPLEMENTED METHOD FOR PROVIDING IMAGE DATA

(71) Applicant: Siemens Healthineers AG, Forchheim (DE)

(72) Inventors: Michael WELS, Bamberg (DE); Ashish JANGRA, Distt. Jhajjar (IN); Felix LADES, Erlangen (DE); Thomas ALLMENDINGER, Forchheim (DE); Markus JUERGENS, Adelsdorf (DE)

(73) Assignee: Siemens Healthineers AG, Forchheim (DE)

(21) Appl. No.: 19/407,123

(22) Filed: Dec. 3, 2025

(30) Foreign Application Priority Data
Dec. 5, 2024 (EP) 24217625.3

(51) Int. Cl. G06T 7/00; G06T 5/50; G06T 5/70; G06V 10/30; G06V 10/764

(52) U.S. Cl. CPC G06T 7/0012; G06T 5/50; G06T 5/70; G06V 10/30; G06V 10/764; G06T 2200/24; G06T 2207/10081; G06T 2207/20081; G06T 2207/30096; G06T 2207/30101; G06T 2211/408; G06T 2211/441

(57) ABSTRACT

One or more example embodiments relates to a computer-implemented method for providing image data based on raw image data of a dual energy computed-tomography arrangement, the method comprising: providing raw image data via a dual energy computed-tomography arrangement, the raw image data comprising low energy image data and high energy image data; providing a tissue classification model, a tissue classification being based on a dual energy ratio of particular low energy image data and particular high energy image data; and utilizing the tissue classification model and providing image data, wherein at least the raw image data are input data of the tissue classification model.

### CROSS-REFERENCE TO RELATED APPLICATION(S)

The present application claims priority under 35 U.S.C. § 119 to European Patent Application No. 24217625.3, filed Dec. 5, 2024, the entire contents of which is incorporated herein by reference.

### FIELD

The present disclosure relates to a computer-implemented method for providing image data based on raw image data of a dual energy computed-tomography arrangement, a system for providing image data based on raw image data of a dual energy computed-tomography arrangement and a corresponding computer program element.

### RELATED ART

Atherosclerotic changes of the vessel wall may have several manifestations. Depending on the tissue composition these plaques may come with a different risk for a patient. Rupture-prone lesions, for instance, have a lipid-rich core while other compositions indicate erosion-prone or rather stable wall changes. For this reason, it is of interest for patient management to gain insights about the underlying structure of atherosclerotic lesions, ideally in a non-invasive manner. As the general tissue types of interest in this case are calcified, lipid-rich, and/or fibrotic tissue, it would be beneficial to distinguish and quantify these in appropriate medical images.

Computed-tomography angiography has long been drawn into consideration for such a task and in particular dual-energy computed-tomography angiography seems to be promising to provide the required insights. While calcifications may be identified easily with both single-energy and the dual-energy computed-tomography, it is more difficult to reliably separate the soft plaque tissue types from each other. For this purpose, dual- or multi-spectral imaging based on photon counting computed-tomography has been considered superior in comparison to merely dual source-based acquisition as perfect geometric alignment of the different spectral 3D scans is an inherent property of photon counting computed-tomography.

### SUMMARY

In this context, it has become apparent that there is a further need to provide a method and/or a system providing an improved tissue classification in raw image data of a dual energy computed-tomography arrangement.

It is therefore an object of the present disclosure to provide a method and/or a system providing/allowing an improved tissue classification in raw image data of a dual energy computed-tomography arrangement.

These and other objects, which become apparent upon reading the following description, are solved by the subject matters of the independent claims. The dependent claims refer to preferred embodiments of the present disclosure.

### BRIEF DESCRIPTION OF THE DRAWINGS

In the following, the present disclosure is further described with reference to the enclosed figures:

FIG. 1 illustrates a flow diagram of a computer-implemented method for providing image data based on raw image data of a dual energy computed-tomography arrangement according to an embodiment of the present disclosure;

FIG. 2 illustrates a system for providing image data based on raw image data of a dual energy computed-tomography arrangement according to an embodiment of the present disclosure;

FIG. 3 illustrates an interactive user interface according to an embodiment of the present disclosure;

FIG. 4 illustrates a geometry of a vessel cross-section with the tissue types lipid-rich, fibrotic, and vessel lumen;

FIG. 5 illustrates a low kV image from the vessel cross-section shown in FIG. 4;

FIG. 6 illustrates a high kV image from the vessel cross-section shown in FIG. 4; and

FIG. 7 illustrates a 2D histogram.

### DETAILED DESCRIPTION

In one aspect of the present disclosure, a computer-implemented method for providing image data based on raw image data of a dual energy computed-tomography arrangement is disclosed, comprising:
providing raw image data via a dual energy computed-tomography arrangement comprising low energy image data and high energy image data;
providing a tissue classification model, wherein a tissue classification is based on a dual energy ratio of low energy image data and high energy image data; and
utilizing the tissue classification model and providing image data, wherein at least the raw image data are input data of the tissue classification model.

In other words, the present disclosure proposes to base the plaque tissue classification in the raw image data of a dual energy computed-tomography arrangement on the dual energy ratio of the low energy image data and the high energy image data. In the past, tissue classification was typically based on the dual energy index or on a direct application of HU values (Hounsfield values). The present disclosure is based on the finding that tissue classification based on a dual energy ratio is very suitable to provide reliable tissue classification. Furthermore, a tissue classification based on the dual energy ratio has additional advantages, which are described in the following in the context of the further embodiments.

The term “raw image data” is to be understood broadly in the present case and may include any image data provided by a dual energy computed-tomography arrangement.

The term “dual energy ratio” is also to be understood broadly in the present case and may encompass any ratio of low energy image data and high energy image data.

The term “tissue classification model” is also to be understood broadly in this context and includes simple fall group distinctions or utilization of formulas. However, more complex evaluation models may also be used. In an example, the evaluation model may comprise at least one trained algorithm, wherein the term “trained algorithm” or “trained evaluation model” as used herein is to be understood broadly in the present case. The algorithm may be a machine learning algorithm. The algorithm may comprise decision trees, naive bayes classifications, nearest neighbors, neural networks, convolutional or recurrent neural networks, transformers, generative adversarial networks, support vector machines, linear regression, logistic regression, random forest, gradient boosting algorithms and/or a diffusion model. Such an algorithm, in particular machine learning algorithm, is termed “intelligent” because it is capable of being “trained.” The algorithm may be trained using records of training data. A record of training data comprises training input data and corresponding training output data. In the context of the present disclosure, training data may, for example may be sets of raw image data, dual energy ratios and image output data. The training output data of a record of training data is the result that is expected to be produced by the algorithm when being given the training input data of the same record of training data as input. The deviation between this expected result and the actual result produced by the algorithm is observed and rated via a “loss function”. This loss function may be used as feedback for adjusting the parameters of the internal processing chain of the algorithm. For example, the parameters may be adjusted with the optimization goal of minimizing the values of the loss function that result when all training input data are fed into the algorithm and the outcome is compared with the corresponding training output data. The result of this training is that given a relatively small number of records of training data as “ground truth”, the algorithm is enabled to perform its job well for a number of records of input data that is higher by many orders of magnitude. Notably, the evaluation model may comprise several or even a large number of different evaluation routines/sub-models. It is also possible to use mixed evaluation routines that combine different evaluation approaches.

In an embodiment of the computer-implemented method, the low energy image data and the high energy image data may be provided as denoised low energy image data and denoised high energy image data. Noise reduction is the process of removing noise from a signal. There are many noise reduction algorithms in image processing, such as nonlocal means, wavelet transform, iterative reconstruction, Deep-Learning-based approaches and others. Non-local means denoising is a patch-based denoising method that compares patches of similar texture or structure across the image to estimate the noise level in each pixel. Wavelet-based denoising is a popular method for reducing noise in CT images. This method involves decomposing the image into different frequency bands using wavelet transforms and then filtering out the noise in each frequency band before reconstructing the image. Iterative reconstruction (IR) algorithms are the most widely used CT noise-reduction method to improve image quality. There are several Deep-Learning approaches for CT image denoising, including but not limited to: convolutional neural networks (CNNs), Generative Adversarial Networks (GANs), Variational Autoencoders (VAEs), Deep Residual Networks (ResNets), Transformer-based methods, Attention-based Networks, as well as hybrid approaches that combine multiple approaches, such as CNNs and GANs, to improve the quality and accuracy of CT image denoising.

In an embodiment of the computer-implemented method, the dual energy ratio may be calculated according to the following formula:

$$r = \frac{{x}_{L} - {u}_{L}}{{x}_{H} - {u}_{H}} ;$$

with
x_{L}: CT value from low energy image data, preferably from the denoised low energy image data;
x_{H}: CT value from high energy image data, preferably from the denoised high energy image data;
u_{L}: predefined CT value for fatty regions for the low energy image data; and
u_{H}: predefined CT value for fatty regions for the high energy image data.

In an embodiment of the computer-implemented method, for CT values from high energy image data x_{H} which are greater than a predetermined buffer value u_{H}B, the dual energy ratio r may be set to 0, wherein the buffer value u_{H}B is preferably set between −89 HU and −95 HU, more preferably between −91 HU and −93 HU and most preferably at −92 HU. Thereby, the influence of noise for x_{H} values close to −92 HU may be reduced.

In an embodiment of the computer-implemented method, u_{L} may be set between −95 HU and −105 HU, preferably between −98 HU and −102 HU and most preferably at −100 HU.

In an embodiment of the computer-implemented method, u_{H} may be set between −87 HU and −97 HU, preferably between −90 HU and 94 HU and most preferably at −92 HU.

In an embodiment of the computer-implemented method, the dual energy ratio r may be assigned as follows:
dual energy ratios r≥1.42 amounts to pure calcium;
dual energy ratios r≤1.0 is fat; and
dual energy ratios in-between 1.0 and 1.42 indicate some mixture tissue.

In an embodiment of the computer-implemented method, a dual energy threshold r* may be provided according to the following formula:

$${r}^{*} = \frac{{δ}_{L}^{*}}{{δ}_{H}^{*}} and {u}_{{H}^{B}}^{*}$$

by
a position of a point p*_{H,L} for changing

$${u}_{L}^{*} and {u}_{H}^{*} = {u}_{{H}^{B}}^{*}$$

and
a rotation α around the point p*_{H,L} with

$${δ}_{H}^{*} > 0 and {δ}_{L}^{*} \geq 0.$$

In an embodiment of the computer-implemented method, a first tissue type may be defined by the region r≥r* and a second tissue type may be defined by the region r<r*.

In an embodiment of the computer-implemented method, the predefined CT value for fatty regions for the low energy image data u_{L}, the predefined CT value for fatty regions for the high energy image data u_{H}, the dual energy ratios assigned to different tissues, the dual energy threshold r*, the predetermined buffer value u_{H}_{^{B}}, the threshold buffer value u_{H}_{^{B}}, the position of the point p*_{H,L}, the rotation α, delta

$${δ}_{L}^{*}$$

and/or the delta

$${δ}_{H}^{*}$$

may be provided via a user interface. In this example, a user may, e.g. via an interactive graphical user interface, a widget, further analyze suspicious vessel wall regions with regards to their soft plaque composition. Such an interactive graphical user interface may be provided as an editor to configure dual energy ratio-based tissue separation in a case-specific manner. This way a user may interactively and intuitively consider acquisition-dependent, e.g. scan parameters, contrast agent concentration, etc., characteristics yielding understandable tissue classifications and associated volumetric measurements from the dual energy computed-tomography arrangement

Such an interactive component may provide immediate intuition of the current configuration and even the less experienced clinical scientist may be able to find configurations that sufficiently well separate soft plaque tissue components in the scans at hand. These scans may have site-specific characteristics due to differing acquisition where tissue separation would be difficult otherwise. Additionally, biological variation from blooming and beam hardening of the contrasted vessel or nearby calcium may ask for very specific dual energy ratio-based thresholding. In this example, initial and automatically suggested case-specific pre-configurations may be conceivable, which could then be adapted manually via a user interface. In contrast to black box approaches, the present disclosure may provide a maximal transparency, i.e. the “decision” to assign sub-voxels to one or the other tissue type may be easy understandable.

In an embodiment of the computer-implemented method, the predefined CT value for fatty regions for the low energy image data u_{L}, the predefined CT value for fatty regions for the high energy image data u_{H}, the dual energy ratios assigned to different tissues, the dual energy threshold r*, the predetermined buffer value u_{H}_{^{B}}, the threshold buffer value u_{H}_{^{B}}, the position of the point p*_{H,L}, the rotation α, delta

$${δ}_{L}^{*}$$

and/or the delta

$${δ}_{H}^{*}$$

may be provided as predetermined parameters. As already mentioned, these parameters may be initially and automatically provided as case-specific pre-configurations, which may then be adapted manually.

Such interactive and transparency aspect of the present disclosure may become important when it comes to achieving tissue separation exactly according to the users' expectation, which in general supports the acceptance of such analysis tools. In certain cases, it may even be a regulatorily required feature to allow manual overriding of results generated by an automatic preprocessing method of any kind, e.g. model fitting, artificial intelligence, etc.

In an embodiment of the computer-implemented method, the predefined CT value for fatty regions for the low energy image data u_{L}, the predefined CT value for fatty regions for the high energy image data u_{H}, the dual energy ratios assigned to different tissues, the dual energy threshold r*, the predetermined buffer value u B the threshold buffer value u_{H}_{^{B}}, the position of the point p*_{H,L}, the rotation α, delta

$${δ}_{L}^{*}$$

and/or the delta

$${δ}_{H}^{*}$$

may be provided by a trained algorithm. Such a trained algorithm may be trained, for example, for a specific application or a specific dual energy computed-tomography arrangement.

Low energy image data and high energy image data may be obtained by any dual energy or multi-energy imaging method, such as photon-counting detection, dual-source CT; rapid kV-switching CT; dual-layer CT; sequential acquisitions using different X-ray tube voltages; split-filter CT.

Photon-counting detection allows spectrally resolved capture of raw X-ray data. In dual-source CT, image acquisitions of one and the same region under examination are performed using at least two different average X-ray energies. Rapid kV-switching CT involves switching the X-ray source between different X-ray energies, so that a plurality of image acquisitions can be performed using different X-ray energies. In dual-layer CT, the detector consists of two or more layers, each of which detects just part of the X-ray spectrum. In sequential acquisitions using a different voltage, the same acquisition is performed twice in quick succession, with the X-ray energy being switched between the acquisitions. In split-filter CT, two different filters, for instance gold and tin, split the X-ray beam longitudinally into two regions, one with a lower spectrum and one with a higher spectrum. Thus in the case of multirow CT, half of the rows detect the low-spectrum signal and the other half detect the high-spectrum signal.

In an embodiment of the computer-implemented method, dual energy computed-tomography arrangement is a photon counting computed-tomography arrangement. The present disclosure may leverage the value of photon counting for quantitative high-risk plaque assessment from angiographic scans in a non-invasive manner.

A further aspect of the present disclosure relates to a system for providing image data based on raw image data of a dual energy computed-tomography arrangement comprising:
a processing circuitry;
a storage medium; and
a data interface;
wherein the storage medium comprises a computer program that comprises instructions which when the program is executed, cause the processing circuitry to carry out the above-explained computer-implemented method;
wherein the data interface is configured to receive input data for the tissue classification model and the raw image data.

A further aspect of the present disclosure relates to a computer program element with instructions, which, when executed on computing devices of a computing environment, is configured to carry out the steps of the above-described computer-implemented in an above-described system. As mentioned, such a computer program element may be provided as interactive graphical user interface, e.g. a widget element. The computer program element might be stored on a computing unit of a computing device, which might also be part of an embodiment. This computing unit may be configured to perform or induce performing of the steps of the method described above. Moreover, it may be configured to operate the components of the above-described system. The computing unit can be configured to operate automatically and/or to execute the orders of a user. The computing unit may include a data processor. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that via an update turns an existing program into a program that uses the present disclosure. Moreover, the computer program element might be able to provide all necessary steps to fulfill the procedure of an exemplary embodiment of the method as described above. According to a further exemplary embodiment of the present disclosure, a computer readable medium, such as a CD-ROM, USB stick, a downloadable executable or the like, is presented wherein the computer readable medium has a computer program element stored on it which computer program element is described by the preceding section. A computer program may be stored and/or distributed on a suitable medium, such as an optical storage medium or a solid-state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

This and embodiments described herein relate to the methods, the systems, the apparatuses, the computer program element, the computer-readable storage medium, the use lined out above and vice versa. Advantageously, the benefits provided by any of the embodiments and examples equally apply to all other embodiments and examples and vice versa. In other words, claims for the system can be improved with features described or claimed in the context of the methods and vice versa. In this case, the functional features of the method are embodied by objective units or modules of the system.

The term “data” as used herein is to be understood broadly in the present case and represents any kind of data. Data may be single numbers/numerical values, a plurality of a numbers/numerical values, a plurality of a numbers/numerical values being arranged within a list, 2 dimensional maps or 3 dimensional maps, but are not limited thereto.

The term “providing” as used herein is to be understood broadly in the present case and represents any providing, receiving, querying, measuring, calculating, determining, transmitting of data, but is not limited thereto. Data may be provided by a user via a user interface, depicted/shown to a user by a display, and/or received from other devices, queried from other devices, measured other devices, calculated by other device, determined by other devices and/or transmitted by other devices.

In the following particularly preferred embodiments are disclosed, which may be combined with the above-disclosed methods, systems, apparatuses, devices and/or use cases. The embodiments described herein may be combined unless specifically noted otherwise. Features and advantages described with respect to one aspect of the disclosure may be applied to other aspects of the disclosure.

The following embodiments are mere examples for implementing the method, the system, disclosed herein and shall not be considered limiting.

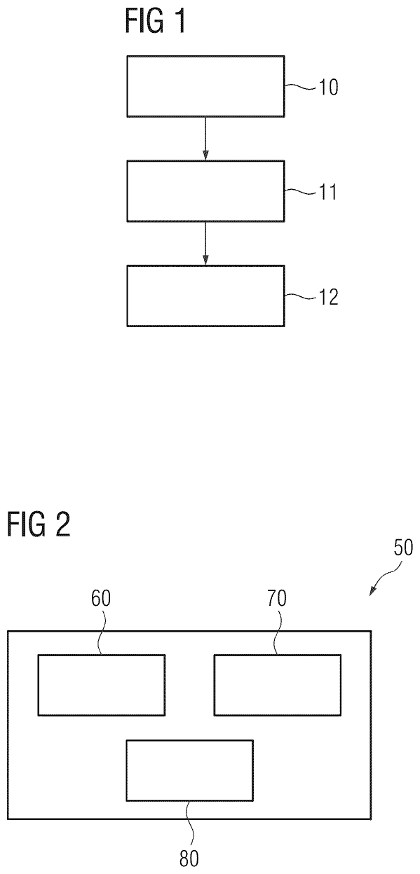

FIG. 1 illustrates a flow diagram of a computer-implemented method for providing image data based on raw image data of a dual energy computed-tomography arrangement according to an embodiment of the present disclosure according to an embodiment of the present disclosure. In a first step 10, raw image data provided via a dual energy computed-tomography arrangement comprising low energy image data and high energy image data are provided. In a second step 11, a tissue classification model is provided, wherein a tissue classification is based on a dual energy ratio of low energy image data and high energy image data. In a further step 12, the tissue classification model is utilized and image data are provided, wherein at least the raw image data are input data of the tissue classification model.

FIG. 2 illustrates a system 50 for providing image data based on raw image data of a dual energy computed-tomography arrangement according to an embodiment of the present disclosure, comprising: a processing circuitry 60, a storage medium 70, and a data interface 80. The storage medium 70 comprises a computer program with instructions which when the program is executed, cause the processing circuitry 60 to carry out the computer-implemented method for providing image data based on raw image data of a dual energy computed-tomography arrangement according to an embodiment of the present disclosure according to an embodiment of the present disclosure. The data interface 80 is configured to receive at least input data for the tissue classification model and the raw image data

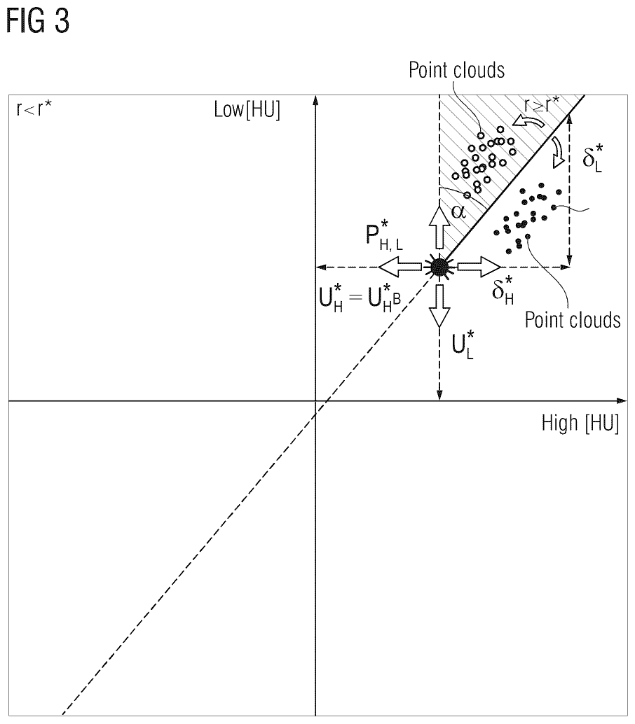

FIG. 3 is a schematically illustration of an interactive user interface. The user interface comprises a 2D histogram where the potentially subsampled voxels of a volume of interest are plotted as point clouds depending on their HU values in the denoised high kV image and low kV image, wherein an interactive user interface element is provided comprising a transferrable point P*_{H,L} from which a rotatable line originates to the upper-right. The degree of rotation is quantified by the angle α relative to the vertical axis. The user interface can be used to partition the feature space into the shown two regions. In the shown example, the dual energy ratio threshold

$${r}^{*} = \frac{{δ}_{L}^{*}}{{δ}_{H}^{*}} and {u}_{{H}^{B}}^{*}$$

by
the position of the point p*_{H,L} for changing

$${u}_{L}^{*} and {u}_{H}^{*} = {u}_{{H}^{B}}^{*}$$

and
the rotation α around p*_{H,L}

$$( with {δ}_{H}^{*} > 0 and {δ}_{L}^{*} \geq 0 ) .$$

This yields two regions r≥r* and r<r* separating two tissue types. This separation may be also used to classify and to quantify plaque compartments in 3D. Also, additional separation lines not necessarily anchored at p*_{H,L} for, e.g., initial calcium separation and other tissue types are conceivable. A possible generalization, may be to define a cascade of dual energy ratio thresholding operations through multiple interactive user interface elements and associated

$${r}_{i}^{*}$$

on top of each other on the same diagram. Moreover, even further higher-level visualizations could be interactively configured: For instance, a color heatmap overlay or segmentation may become conceivable, which is based on the calcification index c=100%*(r−r_{fat})/(r_{ca}−r_{fat}), where the configuration of the first interactive user element may be used for the computation of r and optional additional two elements for r_{ca} and r_{fat} in case they need to be interactively adaptable.

In the shown example, at least the position of the point p*_{H,L} and the rotation α around p*_{H,L} may be changed by a user. Moreover, in the shown example, the dual energy ratio on which a tissue type classification is based, is described as follows:

The dual energy ratio be

$$r = \frac{{x}_{L} - {u}_{L}}{{x}_{H} - {u}_{H}}$$

for x_{H}>u_{H}_{^{B}} and r=0 otherwise with
x_{L}, x_{H}: CT values from L0 and H0
u_{L}, u_{H}: CT values for fatty regions for the low and the high energy image (E.g., choose u_{L}=−100 HU, u_{H}=−92 HU as initial settings for P63A 120 kV scans.)

u_{H}_{^{B}}: buffer value to reduce the influence of noise for x_{H} values close to −92 HU

In the shown example, r≥1.42 amounts to pure calcium, r≤1.0 is fat, and ratios in-between indicate some mixture.

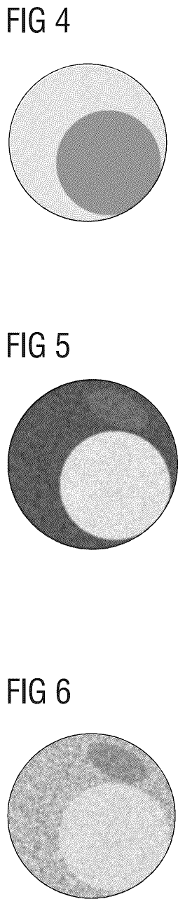

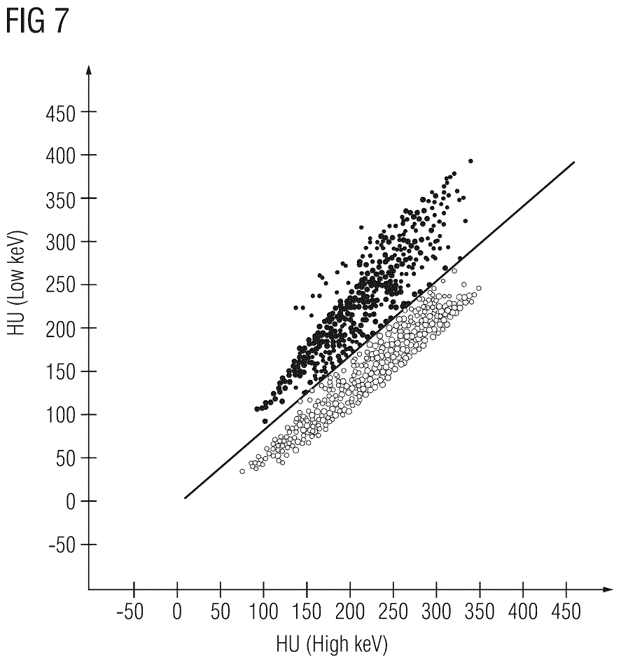

FIG. 4 illustrates a geometry of a vessel cross-section with the tissue types lipid-rich, fibrotic, and vessel lumen. FIG. 5 illustrates the low kV image and FIG. 6 the high kV image from the vessel cross-section shown in FIG. 4 with assumed, ideal-typical HU values. In FIG. 7 the associated 2D histogram is illustrated, wherein the tissue types based on the above explained dual energy ratio and the dual energy ratio threshold are illustrated in FIG. 7. As shown, the via the interactive user interface an almost perfectly separation of the two soft tissue types may be provided.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, the any steps presented can be performed in any order, i.e. example embodiments are not limited to a specific order of these steps. Moreover, it is also not required that the different steps are performed at a certain place or at one node of a distributed system, i.e. each of the steps may be performed at a different node using different equipment/data processing units.

As used herein “determining” also includes “estimating, calculating, initiating or causing to determine”, “generating” also includes “initiating or causing to generate” and “providing” also includes “initiating or causing to determine, generate, select, send, query or receive”.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation. Furthermore, it should be noted that, regardless of the grammatical gender of a particular term, it includes persons with male, female or other gender identities.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PUP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

1. A computer-implemented method for providing image data based on raw image data of a dual energy computed-tomography arrangement, the method comprising:
providing raw image data via a dual energy computed-tomography arrangement, the raw image data comprising low energy image data and high energy image data;
providing a tissue classification model, a tissue classification being based on a dual energy ratio of particular low energy image data and particular high energy image data; and
utilizing the tissue classification model and providing image data, wherein at least the raw image data are input data of the tissue classification model.

2. The computer-implemented method of claim 1, wherein the low energy image data and the high energy image data are provided as denoised low energy image data and denoised high energy image data.

3. The computer-implemented method of claim 2, wherein the dual energy ratio is calculated according to the following formula:
$$r = \frac{{x}_{L} - {u}_{L}}{{x}_{H} - {u}_{H}} ;$$
with
x_{L}: a CT value from the denoised low energy image data;
x_{H}: a CT value from the denoised high energy image data;
u_{L}: a predefined CT value for fatty regions for the low energy image data; and
u_{H}: a predefined CT value for fatty regions for the high energy image data.

4. The computer-implemented method of claim 3, wherein for CT values from high energy image data x_{H} which are greater than a predetermined buffer value u_{H}_{^{B}}, the dual energy ratio is set to 0.

5. The computer-implemented method of claim 3, wherein u_{L} is between −95 HU and −105 HU.

6. The computer-implemented method of claim 3, wherein u_{H} is between −87 HU and −97 HU.

7. The computer-implemented method of claim 4, wherein the dual energy ratio is assigned as follows:
dual energy ratios greater than or equal to 1.42 indicates pure calcium;
dual energy ratios less than or equal to 1.0 indicates fat; and
dual energy ratios between 1.0 and 1.42 indicate some mixture tissue.

8. The computer-implemented method of claim 7, wherein a dual energy threshold r* is provided according to the following formula:
$${r}^{*} = \frac{{δ}_{L}^{*}}{{δ}_{H}^{*}} and {u}_{{H}^{B}}^{*}$$
by
a position of a point p*_{H,L} for changing
$${u}_{L}^{*} and {u}_{H}^{*} = {u}_{{H}^{B}}^{*}$$
and
a rotation α around the point p*_{H,L}, with a high energy delta
$${δ}_{H}^{*} > 0$$
and a low energy delta
$${δ}_{L}^{*} \geq 0 .$$

9. The computer-implemented method of claim 8, wherein a first tissue type is defined by the region r≥r* and a second tissue type is defined by the region r<r*.

10. The computer-implemented method of claim 9, wherein at least one of the predefined CT value for fatty regions for the low energy image data, the predefined CT value for fatty regions for the high energy image data, the dual energy ratios assigned to different tissues, the dual energy threshold, the predetermined buffer value, position of the point, the rotation, the low energy delta or the high energy delta are provided via a user interface.

11. The computer-implemented method of claim 9, wherein at least one of the dual energy ratios assigned to different tissues, the dual energy threshold, the position of the point, the rotation, the low energy delta or the high energy delta are predetermined parameters.

12. The computer-implemented method of claim 8, wherein at least one of the predefined CT value for fatty regions for the low energy image data, the predefined CT value for fatty regions for the high energy image data, the dual energy ratios assigned to different tissues, the dual energy threshold, the predetermined buffer value, the predetermined buffer value, the position of the point, the rotation, the low energy delta or the high energy delta are provided by a trained algorithm.

13. The computer-implemented method of claim 1, wherein the dual energy computed-tomography arrangement is a photon counting computed-tomography arrangement.

14. A system for providing image data based on raw image data of a dual energy computed-tomography arrangement, the system comprising:
a processing circuitry;
a storage medium; and
a data interface;
wherein the storage medium stores instructions that, when executed, cause the processing circuitry to perform the method of claim 1, and
the data interface is configured to receive input data for the tissue classification model and the raw image data.

15. A non-transitory computer-readable medium including instructions, which, when executed on computing devices of a computing environment, cause the computing devices to perform the method of claim 1.

16. The computer-implemented method of claim 4, wherein the predetermined buffer value is between −89 HU and −95 HU.

17. The computer-implemented method of claim 5, wherein u_{L} is −98 HU and −102 HU.

18. The computer-implemented method of claim 6, wherein u_{H} is between −90 HU and −94 HU.
